(19) United States
(12) Patent Application Publication
(10) Pub. No.: US 2009/0327036 A1
(43) Pub. Date: Dec. 31, 2009

(54) DECISION SUPPORT SYSTEMS USING MULTI-SCALE CUSTOMER AND TRANSACTION CLUSTERING AND VISUALIZATION

(75) Inventors: Preston W. Ports, III, Charlotte, NC (US); Debashis Ghosh, Charlotte, NC (US); Weicheng Liu, Huntersville, NC (US); Agus Sudjianto, Charlotte, NC (US); Jie Chen, Charlotte, NC (US); Thayer Allison, Charlotte, NC (US); David Joffe, Charlotte, NC (US); Mack Amin, Dallas, TX (US); Samir Pawar, Charlotte, NC (US); Matt Quinn, Boston, MA (US)

Correspondence Address: Weiss & Arons, LLP, 1540 Route 202, Suite 8, Pomona, NY, 10970, US

(73) Assignee: Bank of America, Charlotte, NC (US)

(21) Appl. No.: 12/206,103

(22) Filed: Sep. 8, 2008

Related U.S. Application Data
(60) Provisional application No. 61/075,785, filed on Jun. 26, 2008.

(51) Int. Cl. G06Q 10/00

(52) U.S. Cl. 705/10

(57) ABSTRACT

Systems, methods and consumer-readable media for using multi-scale customer and transaction clustering and visualization according to the invention have been provided. Systems and methods according to the invention may use program code to obtain customer transaction data and categorize obtained customer transaction data. The systems and methods may also analyze the categorized customer transaction data in order to identify patterns among the data. The systems and methods may also use the identified patterns to isolate a selected number of behavioral factors and group customers into population segments based on the behavioral factors.

### CROSS REFERENCE TO RELATED APPLICATIONS

This application claims priority from U.S. Provisional Patent Application No. 61/075,785 filed Jun. 26, 2008.

### FIELD OF TECHNOLOGY

Aspects of the disclosure relate to systematic improvement of treatment of customers of an entity. Such improvements may include, but not be limited to, improving collection processes, improving targeting of potential customers with product offers and providing improved customer service.

### BACKGROUND

Currently, customer treatments are based on a historical record of success. In some businesses, or lines of business within a business, the historical record of success is limited. For example, Home Equity Recovery has limited history through which to systematically guide future collection efforts.

It would be desirable to provide systems and methods directed to a multi-level and multi-scale clustering of customers using customer-level information.

### SUMMARY OF THE INVENTION

It is an object of this invention to provide systems and methods directed to a multi-scale clustering. For the purposes of this patent application, multi-scale is to be understood as relating to clustering customers using data obtained from different substantive categories such as categories related to financial transaction data, said data being divided along an incremental scale. Systems and methods of this patent application are also directed to multi-level clustering. For the purposes of this patent application, multi-level clustering is to be understood to relate to clustering customers using at least two different categories of substantive data. Preferably, the customer level information may be internal—i.e., within an entity—and external—i.e., outside of an entity—customer level information.

One method of the invention may include analyzing non-linear data in order to identify patterns and features. The method may further include using the identified features to isolate a selected number of behavioral factors. The method may also include grouping customer behavior into customer population segments based on the behavioral factors.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 illustrates a schematic diagram of a general-purpose digital computing environment in which one or more aspects of the present invention may be implemented;

FIG. 2 is an illustrative flow chart and system diagram of a method and system according to the invention; and

FIG. 3 a chart that results from bi-clustering customers with similar transaction behaviors as well as clustering transaction types to visually reveal the patterns.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Typically, financial institutions use conventional customer treatment processes to interact with customers. These conventional customer treatment processes often are based on a FICO credit score or other general modeling technique that is not based on proprietary customer income and spending data.

A method according to the invention is different from current methods in that it:

1. Can use internal customer transaction data to develop customer treatments;

2. Can use external customer data;

3. Can use credit information; and

4. Can provide clusters based on inbound transactions—i.e., a transaction that caused an influx of funds to the customer—and outbound transactions—i.e., a transaction that causes a withdrawal of funds from the customer.

By combining information from the 3 main data sources (1-3 listed above), a method according to the invention can identify similar segments of customers based on spending patterns and their use of credit and debit products.

Certain embodiments of systems and methods according to the invention preferably use Hidden Markov methods and bi-clustering using internal and external customer data to identify population segments. Hidden Markov is a technique that identifies trends and/or patterns in the data. Hidden Markov is similar to taking the data and throwing it into the air and having it drop into segments. This technique allows the customer spend patterns to identify segments, creating a more accurate approach to identifying “like” segments.

More specifically, Hidden Markov is a statistical model in which the system being modeled is assumed to behave like a Markov process with unknown parameters, and the challenge is to determine the hidden parameters from observable parameters. The hidden parameters, once extracted, can then be used to perform further analysis. As stated above, one such example of further analysis may be for pattern recognition.

With respect to customer credit issues, some examples of identified patterns follow:

“Over-Spenders” defined as customers that spend more than they make.

“Life Events”, defined as customers that have a major life event.

Systems and methods according to the invention preferably apply different treatments for customers. For example, certain customers may become delinquent in view of historical behavior. As such, embodiments of the invention seek to categorize customers according to their behavioral similarities.

Systems and methods according to the invention may be particularly useful in dealing with home equity customers. In the home equity business, there is a lack of transparency related to specific customer behaviors as to why certain customers go delinquent and eventually charge-off (pre-default). Systems and methods according to the invention preferably apply different, preferably more targeted, treatments for customers based on the fact that the customers may go delinquent in view of historical behavior. A system that can add transparency to Home Equity borrower behavior is very useful in improving efficiencies of the Home Equity system.

Benefits to use of systems and methods according to the invention may include better collections. Further benefits may include improved customer experience since an entity that utilizes the methods according to the invention may have a better understanding of why a customer has gone delinquent or is unable to pay bills and, consequently, can be more sensitive to the needs of the individual customer. In such circumstances, the entity can provide different solutions based on more complete knowledge of the customer.

Systems and methods according to the invention may also preferably obtain better treatment for the customer. The ability to tailor discussions with individual customers and provide more directed and accurate offers may improve the customer experience because the accuracy of the offers show that the lending entity knows the customer's position and is positioned to help them improve on the customer's situation. For example, if the entity is aware that the customer is overspending, the entity can offer financial counseling or recommend areas to reduce spending in order to pay off debt.

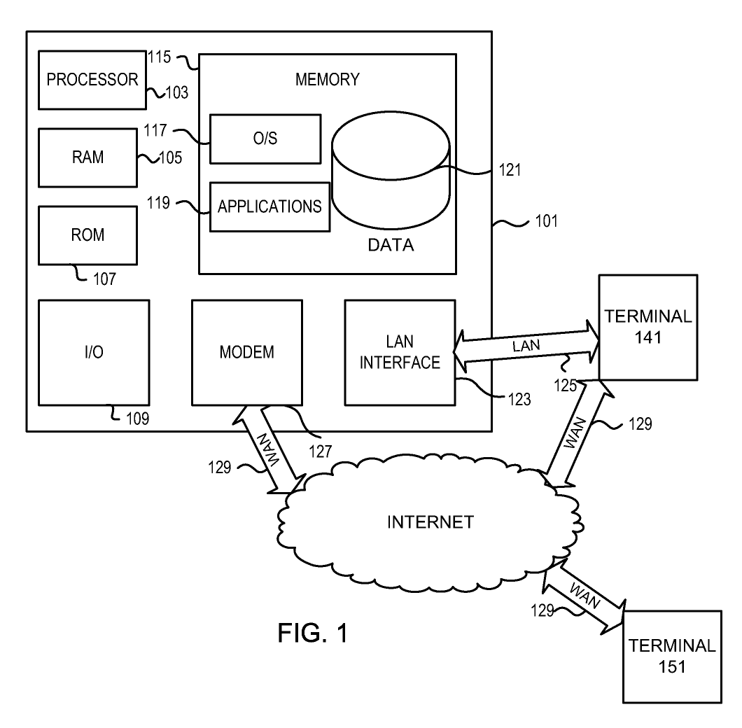

FIGS. 1-3 show illustrative embodiments of the invention.

FIG. 1 illustrates a block diagram of a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

I/O module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown). As described in detail below, database 121 may provide centralized storage of account information and account holder information for the entire business, allowing interoperability between different elements of the business residing at different physical locations.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119 used by server 101 according to an illustrative embodiment of the invention may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

There can be three main data sources for this invention: internal data, credit data and external data.

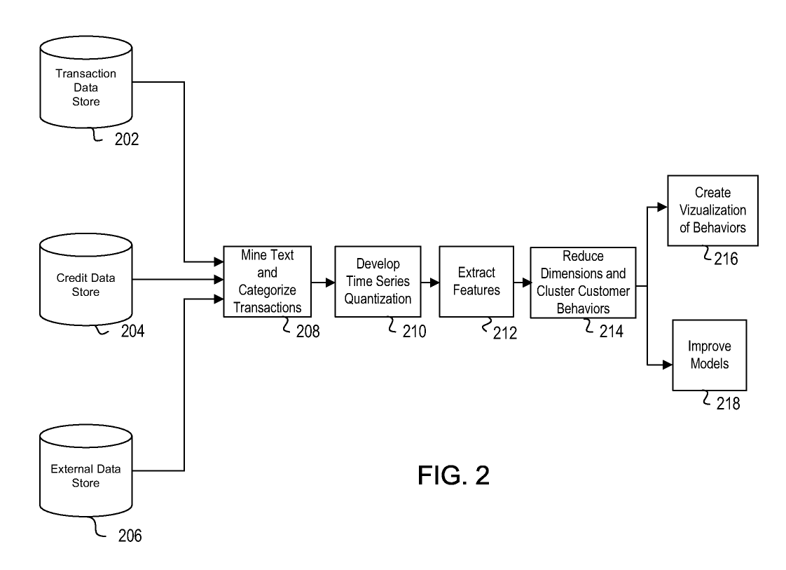

The data may be consolidated using the process shown in FIG. 2. FIG. 2 is an illustrative flow chart and system diagram of a method and system according to the invention. A system according to the invention may preferably include a transaction data store 202, a credit data store 204 and an external data store 206. The external data store 206 may or may not form a part of a system according to the invention.

Step 208 shows mining text and categorizing transactions according to the invention. Preferably, code may be used to identify data sources and categorize the information.

Step 210 shows developing time series quantization. This step preferably may be used to analyze non-linear data—i.e., data not in descending order, ascending order or in any other linear combination that can be used to describe the longitudinal pattern of the consumer behavior—in a time series that assists in the identification of patterns and features.

Step 212 shows extracting features according to the invention. Step 212 preferably uses various techniques, which may include a Hidden Markov technique, to find patterns within the customer transaction data.

Step 214 shows reducing dimensions and clustering customer behaviors. Step 214 uses the identified features to isolate a selected number of factors and then groups customers into population segments based on behavioral characteristics. These groupings can be helpful in guiding initiation of different, more targeted and/or more appropriate, treatments within collections, servicing, offers management, etc.

Step 216 shows creating visualization of behaviors. Such creation of visualization may include determining a more optimal process to show data to judgmental lenders, collectors and other associates and create usable information/screens.

Step 218 shows improving models. Step 218 may include using data to improve existing models and/or introduce as factors into new models.

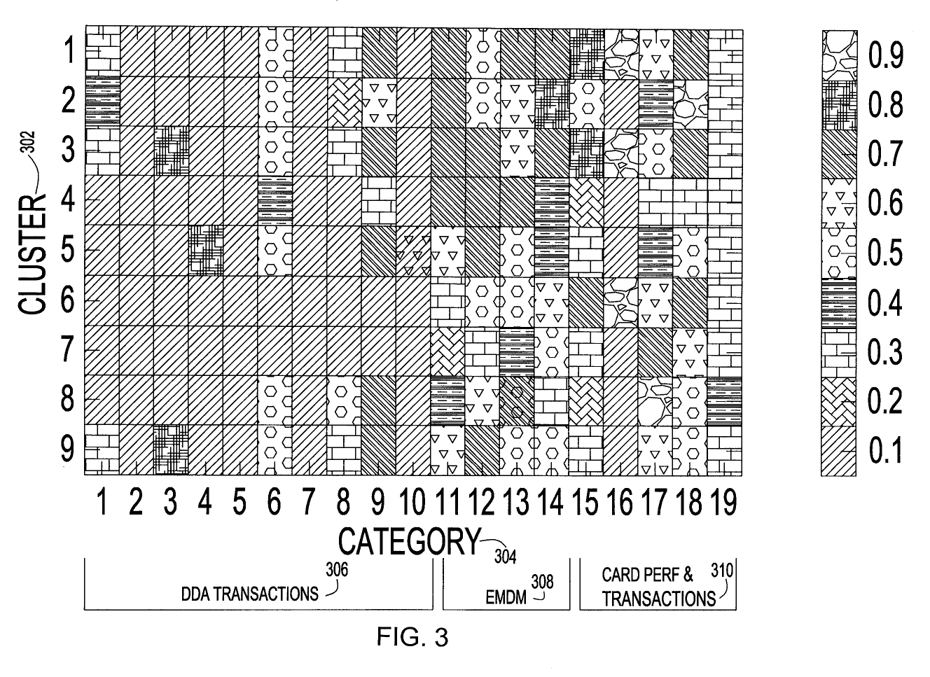

FIG. 3 shows a chart obtained from clustering customers according to the invention. Preferably, the chart shows clustering customers according to based on transaction behavior. The clustering obtained by using transaction types may then be used to visually indicate patterns of customer behavior. The numbers on the y-axis of the chart correspond to clusters 302 obtained from dividing users based on the information obtained from the categories.

The alpha-numeric indications along the x-axis of the chart represent possible categories 304 of occurrences that may trigger clustering of various individuals into various clusters or baskets. The categories along the x-axis have been further divided into groups of information obtained from Demand Deposit Accounts (“DDA”), wherein deposits can be drawn at any time without notice, Enterprise Marketing Data Mart (EMDM), a proprietary data mart which can be used to illustrate the consumer static view of their respective relationships with a predetermined entity, and credit card performance and transactions.

The numbered scale to the right of the grid is a scale that indicates the level of importance of the categories, 10 being the most important. The different textures represent indications of transaction intensity (dollar volume and frequency).

Table 1 sets forth definitions of the different categories.

TABLE 1
Category Definitions

| Category | Definition |
|---|---|
| 1 | Incoming: Card Advance, Card Balance |
| | Transfer, Loans, HELOC (“Home Equity Line Of |
| | Credit”) to DDA |
| 2 | Incoming: Brokerage Accounts |
| 3 | Incoming: Payroll |
| 4 | Incoming: Social Security/Pension |
| 5 | Incoming: Unemployment |
| 6 | Outgoing: Car/Card/Loans/Mortgage/HELOC |
| | Payments |
| 7 | Outgoing: Brokerage Accounts |
| 8 | Outgoing: NSF/Overdraft Fees |
| 9 | Outgoing: DDA Purchases + Utility |
| 10 | Total Payday Loans |
| 11 | Bank Deposits/Investments |
| 12 | Bank Deposits/Investments (% Change) |
| 13 | Bank Loans |
| 14 | Bank Loans (% Change) |
| 15 | Credit Card Spending |
| 16 | Credit Card Recreation/Food Ratio |
| 17 | Credit Card Utilization |
| 18 | Credit Card Utilization (% Change) |
| 19 | Credit Card Delinquency |

Table 2 includes a sample of 5406 bank customers that were divided into clusters using systems and methods according to the invention.

TABLE 2
Customers Per Cluster

| | Cluster No. | | | | | | | | | |
|---|---|---|---|---|---|---|---|---|---|---|
| | 1 | 2 | 3 | 4 | 5 | 6 | 7 | 8 | 9 | Total |
| No. of | 715 | 760 | 322 | 668 | 286 | 479 | 828 | 739 | 609 | 5406 |
| Customers | | | | | | | | | | |
| Percent of total | 13.2 | 14.1 | 6.0 | 12.4 | 5.3 | 8.9 | 15.3 | 13.7 | 11.3 | 100.0 |

Based on the clustering result, specific treatment can be designed and implemented for each cluster of customers. The multi-level and multi-scale approach allows user of the system to obtain more granular clustering both from customers and transaction type point of view. At the most granular level, the transactions at a customer level can be identified and analyzed.

The following are examples of characteristics of various exemplary clusters shown in FIG. 3.

Cluster #3 includes multiple dominant features; high payroll, high credit card spending, and high recreation/food ratio. Cluster #3 also includes some incoming borrowing and overdrafts, high level spending using DDA, and median level debt service payment. Cluster #3 also is characterized by median to high level bank deposits/investments as well as low, but non-trivial, card utilization.

Cluster #5 includes a single dominant feature of a high social security income as well as a pension income. Cluster #5 also includes a median level debt service payment and spending using DDA. Other characteristics of cluster #5 include low spending with credit cards and median level bank deposits and investments.

Cluster #6 is characterized by no DDA transactions, low bank deposits/investments and loans. Additional characteristics of cluster #6 include high credit card spending, and high recreation/food ratio.

Cluster #8 includes no payroll deposit to the institution, low bank deposits/investments, a high level of credit card delinquency, high credit card utilization, and a low level of credit card spending, median level spending and debt service payment using DDA, and high overdrafts.

Each of the foregoing represents exemplary clusters obtained by clustering a group of bank customers based on the aforementioned categories. The invention may further comprise assigning specific treatments to different clusters. Preferably, the treatments depend on the individual characteristics associated with the cluster.

The invention is operational with numerous other general purpose or special purpose computing system environments or configurations. Examples of well known computing systems, environments, and/or configurations that may be suitable for use with the invention include, but are not limited to, personal computers, server computers, mobile phones and/or other personal digital assistants (“PDAs”), other hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Aspects of the invention have been described in terms of illustrative embodiments thereof. A person having ordinary skill in the art will appreciate that numerous additional embodiments, modifications, and variations may exist that remain within the scope and spirit of the appended claims. For example, one of ordinary skill in the art will appreciate that the steps illustrated in the figures may be performed in other than the recited order and that one or more steps illustrated may be optional. The methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures. Thus, decision support systems and methods for using multi-level, preferably multi-scale, customer and transaction clustering and visualization according to the invention have been provided. Persons skilled in the art will appreciate that the present invention can be practiced by other than the described embodiments, which are presented for purposes of illustration rather than of limitation, and the present invention is limited only by the claims which follow.

What is claimed is:

1. One or more computer-readable media storing computer-executable instructions which, when executed by a processor on a computer system, perform a method for providing decision support systems using customer clustering, the method comprising:
using program code to obtain customer transaction data and categorize obtained customer transaction data;
analyzing the categorized customer transaction data in order to identify patterns among the data;
using the identified patterns to isolate a selected number of behavioral factors; and
grouping customers into population segments based on the behavioral factors.

2. The method of claim 1, the analyzing data comprising analyzing the data using a Hidden Markov method.

3. The method of claim 1 further comprising providing a graphical description of the behavioral segments.

4. The method of claim 1 further comprising using program code to identify customer transaction data sources.

5. The method of claim 1 the obtaining customer transaction data comprising obtaining data from at least two data sources.

6. The method of claim 5 wherein the two data sources are selected from internal customer transaction data, external customer transaction data, and customer credit information.

7. The method of claim 1 further comprising providing a set of guidelines to administer different treatments based on the behavior segments.

8. A method for providing decision support systems using customer clustering, the method comprising:
identifying customer transaction data sources;
obtaining customer transaction data;
categorizing obtained customer transaction data, the obtained data including linear data and non-linear data;
analyzing non-linear data in order to identify patterns among the data;
using the identified patterns to isolate a selected number of behavioral factors; and
grouping customers into segments based on the behavioral factors.

9. The method of claim 8, the analyzing non-linear data comprising analyzing the non-linear data using a Hidden Markov method.

10. The method of claim 8 further comprising providing a visual indication of the behavioral segments.

11. The method of claim 8 further comprising using the obtained data to improve existing models.

12. The method of claim 8 further comprising administering different treatments to different behavior segments.

13. The method of claim 12 the administering different treatments comprising, in areas of collections, servicing, and/or offers management, administering the different treatments to the behavioral segments.

14. A system for providing decision support systems using customer clustering, the system configured to:
receive customer transaction data;
identify patterns among the customer transaction data;
use the identified patterns to isolate a selected number of behavioral factors; and
group customers into segments based on the behavioral factors.

15. The system of claim 14, the analyzing non-linear data comprising analyzing the non-linear data using a Hidden Markov method.

16. The system of claim 14 further comprising providing a graphical display of the behavioral segments.

17. The system of claim 14 a display for displaying different treatments for use with different behavior segments.

18. The system of claim 14 further configured to obtain data from at two of the following sources: internal customer transaction data, external customer transaction data, and customer credit information.

19. The system of claim 14 further configured to identify customer transaction data sources.
